(19) United States
(12) Patent Application Publication
(10) Pub. No.: US 2020/0346054 A1
(43) Pub. Date: Nov. 5, 2020

(54) AIRBURST DELIVERY SYSTEM

(71) Applicant: FF Stopper LLC, St. Louis, MO (US)

(72) Inventors: Scott Corley, Flemington, MO (US); Jim Gore, Fairview Heights, IL (US)

(21) Appl. No.: 16/865,955

(22) Filed: May 4, 2020

Related U.S. Application Data
(60) Provisional application No. 62/842,442, filed on May 2, 2019.

(51) Int. Cl. A62C 3/02; B64D 1/04; F42B 12/20

(52) U.S. Cl. CPC A62C 3/025; F42B 12/202; B64D 1/04

(57) ABSTRACT

An airburst delivery system that may provide for effective delivery of firefighting material to forest fires. The system generally utilizes an explosive charge to detonate a frangible containment vessel filled with firefighting material above the earth and typically above fire in a forest canopy. The resulting expanding sphere of water and related shockwaves provides a multi-effect interaction with the fire resulting in multiple water soakings combined with the sue of the vacuum and compression created by the shockwave to starve the fire of fuel and oxygen.

### CROSS-REFERENCE TO RELATED APPLICATIONS

This application claims the benefit of U.S. Provisional Patent Application No. 62.8 42,442, filed May 2, 2019, the entire disclosure of which is incorporated herein by reference.

### BACKGROUND OF THE INVENTION

### Field of the Invention

This disclosure is related to the field of fire retardant delivery systems, and more specifically to a delivery system which can assist firefighters in successfully combatting forest fires.

### Description of the Related Art

Firefighters have been fighting forest fires in the United States, as well as abroad, in order to prevent or minimize the loss of life and property damage for many years. Further, fires are controlled in order to minimize their effect on forests and related ecosystems. Firefighters use many different techniques and tools to fight fires. In forest fires, firefighters may use different control schemes to fight fires, including direct and indirect measures. Direct firefighting includes all efforts to actively suppress or extinguish the fire. This includes the direct application of water and/or fire retardant chemicals to the fire via aircraft or ground based pumping. Indirect firefighting includes efforts to contain an existing fire, such as creating fire breaks where fuel for the fire is removed, and the application of water or chemicals to unburned fuel. Fuel for fires includes any combustible material, such as trees, underbrush, and decomposing organic matter.

Fighting forest fires often requires a different approach than fighting localized fires in an urban environment. For localized fires, such as a fire engulfing a single structure, it is generally most efficient to combat the fire from the ground using conventional firefighting equipment, such as fire trucks and fire suppressing infrastructure engineered into the building itself. On the other hand, forest fires may require more specialized equipment and the use of several different firefighting techniques to bring the blaze under control. This is due, to both the inaccessibility and the size or potential size of forest fires.

In many cases, forest fires are too remote for conventional, ground based firefighting equipment to be present and the time for the conventional, ground based firefighting equipment to access the forest fire may be too long. Further, a large scale forest fire may produce sufficient heat to require a stand-off zone around the fire which firefighters may not enter safely. Depending on the size of the stand-off zone, some conventional, ground based firefighting equipment may be unable to directly combat the fire. Further, such large forest fires may move more quickly than can be accommodated safely by personnel on the ground. Additionally, some forest fires may be of the scale and intensity that they produce their own weather system, effectively making the forest fire's movement unpredictable. In such cases, remote firefighting activities may be required.

Remote firefighting activities may be classified into two different classes of firefighting actions: (1) remote ground operations and (2) aerial operations. Remote ground operations tend to include various indirect firefighting activities taken to condition the forestland surrounding a fire with the hopes of containing or slowing the spread of the fire. As discussed above, these activities include measures taken to reduce the available fuel in areas surrounding the fire. This may include treating forest material with water or fire retardant chemicals to lessen the forest materials' tendency to burn quickly.

This may also include controlled burns of underbrush to reduce the available fuel for the incoming forest fire. These actions may further include the removal of substantially all fuel, including trees and underbrush, in large lines or swaths with the hopes of creating an if oxidizable barrier between the approaching fire and surrounding forestland. Firefighters may take advantage of prebuilt fire brakes, such as roads and water features, in addition to clearing the forestland.

Aerial firefighting operations include various forms of firefighting conducted from the air using aircraft, such has airplanes and helicopters. Aerial firefighting may include the deployment of firefighters to the ground by rappelling or parachute. These firefighters, also known as smokejumpers, combat the forest fire from the ground once deployed, generally using the indirect firefighting techniques discussed above. Aircraft may be used to deliver water or fire retardant chemicals to the forest fire or to the surrounding forestland. Water or fire retardant chemical delivery may be accomplished using water tanks internal to the aircraft, For example, specially designed airplanes may pick up or, siphon water from an available water source, such as a lake, and store that water in, an internal tank. The water may then be delivered to the forest fire by the pilot or airplane crew opening the tank at an appropriate time over or near the forest fire. Helicopters may use internal tanks or external containers to carry and deliver water to a forest fire in a similar fashion. Aerial operations may also include the delivery of explosive firefighting munitions to or around a forest fire.

Such explosive firefighting munitions have been described in, for example, U.S. Pat. Nos. 4,285,403 and 7,261,165, the entire disclosures of which are herein incorporated by reference. U.S. Pat. No. 4,285,403 discloses a waterproof explosive charge suspended within a frangible, spherical shell having an aqueous firefighting solution therein. The explosive is detonated either by an impact trigger and/or a timing fuse to create a vapor-like fog. The fog and effects of the explosion are used to lessen the intensity of and to combat forest fires. As another example, U.S. Pat. No. 7,261,165 discloses a cylindrical, multi-part chamber housing a central explosive charge and a fire retardant chemical. The cylindrical chamber is loaded and delivered to a forest fire, detonating on impact using an impact trigger.

Although explosive firefighting munitions may be deployed to fight fires in a variety of situations, such explosive firefighting munitions often perform less than optimally, and their use has been severely limited. For example, explosive firefighting munitions that trigger upon impact with the ground may not effectively fight fires that have enveloped the canopy of the forest due to limitations on how far the firefighting material inside the explosive firefighting munitions may be projected. As another example, explosive firefighting munitions that use timing fuses may not be detonated at a predictable height above ground. This leads to unpredictable distribution of the firefighting material within the explosive firefighting munitions. Further, when explosive firefighting munitions are detonated too high above an active fire within the canopy of the forest, super-heated wind caused by the heat dissipated by the fire may divert away the firefighting material from the intended target. Further, the water may evaporate and disperse to an extent that what water does interact with the fire is ineffective.

### SUMMARY OF THE INVENTION

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein, among other things, is an airburst delivery system that may provide for effective delivery of firefighting material to forest fires. This airburst delivery system may also provide additional benefits of effectively spreading the firefighting material and limiting the amount of oxygen available to the fire via the concussive force and vacuum created by the explosion. The system generally utilizes an explosive charge to detonate a frangible containment vessel filled with firefighting material above the earth and typically above fire in a forest canopy. The resulting expanding sphere of water and related shockwaves provides a multi-effect interaction with the fire resulting in multiple water soakings combined with the sue of the vacuum and compression created by the shockwave to starve the fire of fuel and oxygen.

In an embodiment, there is described herein, an airburst delivery system for assisting in firefighting and a method for using such a system, the system comprising; a frangible containment vessel; a firefighting material within the containment vessel; an, explosive charge within the firefighting material; and a detonator for the explosive charge; wherein the detonator triggers the explosive charge during descent of the containment vessel from an elevated position toward earth prior to the frangible containment vessel contacting the ground.

In an embodiment of the airburst delivery system, the firefighting material comprises water.

In an embodiment of the airburst delivery system, the detonator includes an altimeter.

In an embodiment of the airburst delivery system, the detonator includes a thermal sensor.

In an embodiment of the airburst delivery system, the containment vessel comprises a rubber blivet.

In an embodiment of the airburst delivery system, the explosive charge comprises C-4 Plastic explosive.

In an embodiment of the airburst delivery system, the explosive charge comprises an M112 demolition charge.

In an embodiment of the airburst delivery system, the system is used in fighting forest fires,

In an embodiment of the airburst delivery system, the detonator triggers the explosive charge above a top edge of a tree canopy.

In an embodiment of the airburst delivery system, the detonator triggers the explosive charge below a top edge of a tree canopy but above the ground.

In an embodiment of the airburst delivery system, the system is carried by an aircraft.

In an embodiment of the airburst delivery system, the aircraft is an airplane.

In an embodiment of the airburst delivery system, the system is carried within the airplane.

In an embodiment of the airburst delivery system, the aircraft is a helicopter.

In an embodiment of the airburst delivery system, the system is carried under the helicopter.

### BRIEF DESCRIPTION OF THE DRAWINGS

FIG. 1 provides a view of an embodiment of an airburst delivery system.

FIG. 2 provides a plan, interior view of an airplane holding an embodiment of an airburst delivery system.

FIG. 3 shows a perspective view of a helicopter holding an embodiment of an airburst delivery system.

FIG. 4 shows a perspective view of an embodiment of an airburst delivery system being deployed over a forest.

### DESCRIPTION OF THE PREFERRED EMBONMENT(S)

The following detailed description and disclosure illustrates by way of example and not by way of limitation. This description will clearly enable one skilled in the art to make and use the disclosed systems and methods, and describes several embodiments, adaptations, variations, alternatives and uses of the disclosed systems and methods. As various changes could be made in the above constructions without departing from the scope of the disclosures, it is intended that all matter contained in the description or shown in the accompanying drawings shall be interpreted as illustrative and not in a limiting sense.

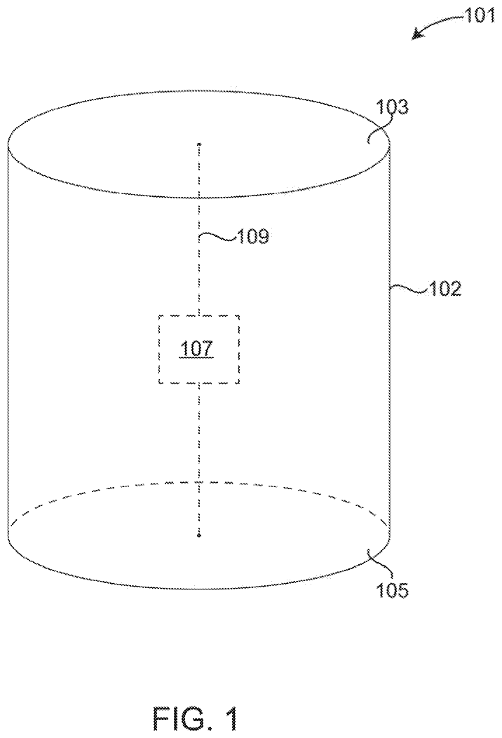

FIG. 1 shows an embodiment of an airburst delivery system (101). The airburst delivery system (101) includes a containment vessel (102) having a top portion (103) and a bottom portion (105). The containment vessel (102) may have a substantially cylindrical shape, as is shown in FIG. 1. In other embodiments, the containment vessel (102) may have any other shape, such as a generally spherical shape. In yet other embodiments, the containment vessel (102) may have a complex or asymmetric shape. The containment vessel (102) may be made of any material suitable for containing or carrying the various parts of the airburst delivery system (101). In one embodiment, the containment vessel (102) is made of rubber. In other embodiments, the containment vessel (102) may be made of laminated materials.

In the embodiment shown in FIG. 1, the containment vessel (102) has a single chamber to contain the parts of the airburst delivery system (101). In other embodiments, the containment vessel (102) may have multiple chambers. The containment vessel (102) may be of any size and shape. In an embodiment, the containment vessel (102) is a 1,000 gallon collapsible rubber fuel blivet, similar to those used by the United States military or similar device.

An explosive charge (107) may be disposed within the containment vessel (102). In the embodiment shown in F1G. 1, the explosive charge (107) is suspended within the containment vessel (102) by some tethers (109), which are attached. to the top portion (103) of the containment vessel (102) and the bottom portion (105) of the containment vessel (102). The explosive charge (107) may be located in a position substantially equidistant from the top portion (103) of the containment vessel (102) and the bottom portion (105) of the containment vessel (102). In other embodiments, the explosive charge (107) may be located in a different position, for example, proximate to the top portion (103) of the containment vessel (102) or, alternatively, proximate to the bottom portion (105) of the containment vessel (102). In other embodiments, the explosive charge (107) may be located outside of the containment vessel (101) or the explosive charge (107) may be located within the walls of the containment vessel (102).

In yet other embodiments, the explosive, charge (107) may be located within the center of the containment vessel (102) using other techniques. For example, the explosive charge (107) may be located within the center of the containment vessel (102) using an integrated holding portion of the containment vessel (102) itself that extends into the center of the containment vessel (102). In other embodiments, the explosive charge (107) may be located within the center of the containment vessel (102) using a different material that extends from the walls of the containment vessel (102) into the center of the containment vessel (102). In a still further embodiment, the explosive charge may have a selected buoyancy so as to suspend it at the desired point in the containment vessel (102).

The explosive charge (107) may be any explosive material and will generally be connected to a detonator of appropriate type. In an embodiment, the explosive, is a plastic explosive, such as a United States military N112 demolition charge, which is made of C-4 plastic explosive material. Other materials may be used for the explosive charge (107), including other chemical explosives, however it is generally preferred that the chosen explosive material be capable of detonating even when wet. In a still further embodiment, the explosive charge (107) can be replaced by a system which creates a shockwave in the manner of an explosive charge, but is not commonly thought of as a munition. For example, the explosive charge (107) could comprise chemicals that when mixed produce a rapidly expanding gas, liquid, or solid which in turn would generate a shockwave when interacting with external material, or could comprise a mechanical device such as a piston which can move rapidly to compress a nearby fluid and create a shockwave.

The containment vessel (102) is filled with water or another firefighting material, such as a chemical fire retardant of a type known to a person having ordinary skill in the art. The firefighting material will typically be liquid, but this is not required and it may, in alternative embodiments be gaseous, be another type of fluid, be a foam, be a material in solution, or may be in any other state of matter. The containment vessel (102) may be fully or partially filled with the firefighting material. In the primarily discussed embodiment, the containment vessel (102) is filled with water for simplicity of understanding. In another embodiment, the containment vessel (102) is filled with a fire retardant foam.

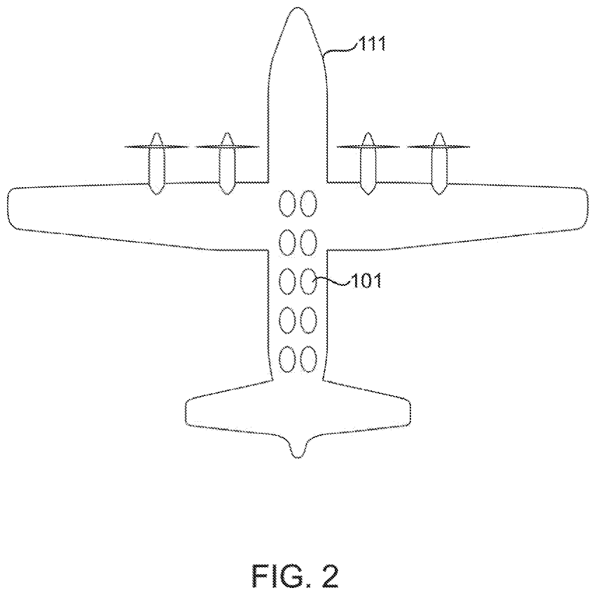

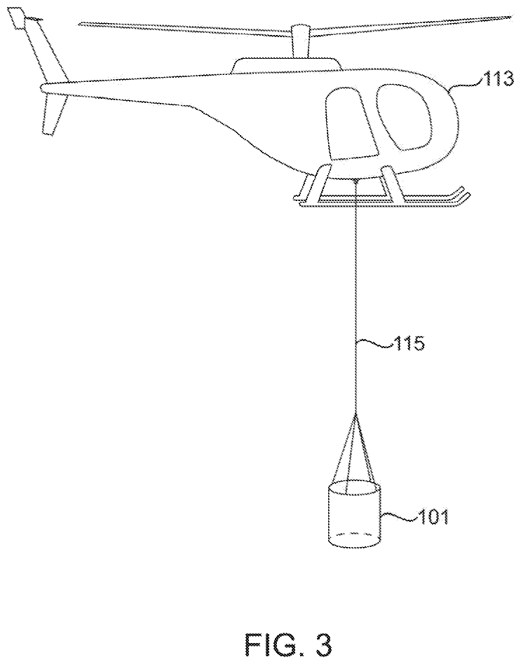

The airburst delivery system (101) may be delivered to a fire, such as a forest fire, using an aircraft. Such aircraft include airplanes (111) and helicopters (113) as shown in FIGS. 2 and 3, respectively. FIG. 2 shows a plan, interior view of an airplane (111), such as a Lockheed C-130 Hercules airplane, loaded with ten airburst delivery systems (101). In other embodiments, more or less airburst delivery systems (101) may be loaded in the airplane (111). Each airburst delivery system (101) may be deployed from the airplane (111) individually. Alternatively, the airplane (111) may deploy the airburst delivery systems (101) in groups of any size, and the group sizes may vary during deployment. Such airburst delivery systems (101) may be deployed via aircraft cargo doors (such as simply by being pushed out of the door in flight), could be deployed using weapon deployment systems (such as bomb or missile racks), or can be deployed by other deployment systems appropriate for the selected aircraft (e.g. those for airdrop of cargo via parachute).

FIG. 3 shows a perspective view of a helicopter (113) holding an airburst delivery system (101). As shown, the airburst delivery system (101) may be tethered to a helicopter (113) using a tether (115). In an embodiment, the tether (115) includes multiple points of connection to the airburst delivery system (101). In other embodiments, the tether (115) may include only a single point of connection to the airburst delivery system (101). FIG. 3 shows a single airburst delivery system (101) tethered to the helicopter (113). In other embodiments, two or more airburst delivery systems (101) may be tethered to the helicopter (113).

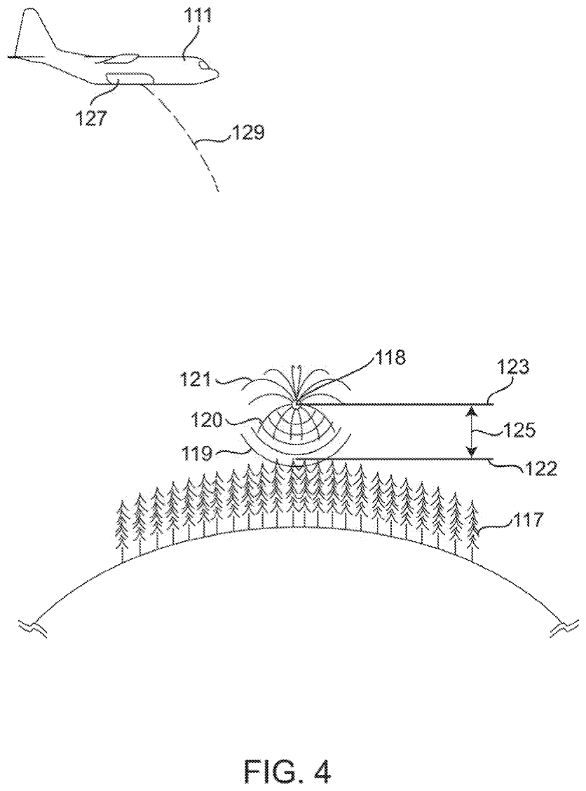

FIG. 4 shows a perspective view of an airburst delivery system (101) being deployed from an airplane (111) to fight a fire in a forest (117). The airplane (111) includes a door (127), which in the depicted drawings is a bomb bay door located within the fuselage but may alternatively or additionally be a cargo door such as those commonly located at the rear of an aircraft. The airburst delivery system (101) may be dropped through the door (117) by any conventional means for dropping objects from such an aircraft to deploy the airburst delivery system (101). Once dropped, the airburst delivery system (101) follows a trajectory (129), which is generally curved due to the airspeed of the airplane (111) relative to the ground. The forest (117) includes trees that form a canopy, and the canopy has a top end (112). In an embodiment, the trajectory, speed, or orientation of the system (101) may be altered through the inclusion of a parachute, airfoils, or other device or devices (not shown) to alter the drag on the system (101).

The explosive charge (107) within the airburst delivery system (101) will generally be detonated by a detonator attached thereto. The detonator will typically be triggered in a manner that causes the explosive charge to detonate above the ground (“airburst”). In an embodiment, this can be accomplished with the detonator including an altimeter. This arrangement allows the explosive charge (107) to be detonated at a preselected altitude. In an embodiment, the altitude of detonation (123) for the airburst delivery system (101) may be above the top end (112) of the canopy of the forest (117). The distance (125) between the altitude of detonation (123) for the airburst delivery system (101) and the top end of the canopy (112) may be between 20 and 100 feet. In other embodiments, the distance (125) between the altitude of detonation (123) for the airburst delivery system (101) and the top end of the canopy (112) may be between 50 and 70 feet. In yet other embodiments, the altitude of detonation (123) for the airburst delivery system (101) may be below the canopy of the forest (117) but still above the ground.

In another embodiment, the explosive charge (107) may include a thermal sensor connected to the detonator in order to detonate the airburst delivery system (101) once the airburst delivery system (101) encounters a predetermined thermal quantity. This can allow for the height of the explosive charge (107) above the top end of the canopy (112) to be based on fire intensity at the drop site as opposed to specific altitude. In farther alternative embodiments, other systems can be included with the detonator to facilitate the in-air detonation of the explosive charge including manual systems triggered by personnel on the aircraft or on the ground.

FIG. 4 also shows an example of a point of detonation (118) for airburst delivery system (101) where the explosive charge (107) is generally centered within the containment vessel (102) which is filled with water. When the explosive charge (107) is detonated, the containment vessel (102) will typically fracture in multiple directions from the pressure of the explosive shockwave compressing the water against the inner surface of the containment vessel (102). This fracture will generally result in the water (and parts of the containment vessel (102)) being directed in a loose sphere away from the original position of the explosive charge (107). The expanding sphere of water will generally not be truly spherical due to effects on the water including air resistance, the location and size of fragments of the containment vessel (102), the motion of the containment vessel (102) prior to the explosive charge (107) detonation, and the particular shape and orientation of the explosive charge (107) and containment vessel (102) at detonation. However, it is conceptually useful to consider the water dispersion pattern as generally spherical.

As can be seen in FIG. 4, a first portion (120) of the water within the airburst delivery system (101) is directed downwards (towards the earth) from the point of detonation (118). Further, a second portion (121) of the water within the airburst delivery system (101) is directed upwards from the point of detonation (118). This opposite movement of the water is believed to assist an embodiment of the airburst delivery system (101) in fighting fires at least because much of the area where the first portion of water (120) falls (due to gravity) will also be where the second portion of water (121) falls subsequently. This two-phased wetting may assist in extinguishing fire. Further assistance is believed to made by the concussive force (shockwave) (119) of the explosion from the explosive charge (107).

The concussive force (119) of the explosion from the explosive charge (107) will generally remove a large amount of available oxygen from the area surrounding the point of detonation (118) and may also serve to scatter available fuel from the detonation area. Specifically the concussive force (117) may first serve to force air, fuel, and water into the earth. This can have a snuffing effect as there is no space for the oxidation of the fire to occur. The concussive force (117) will then typically rebound from the earth and spread outward from the impact point with the earth. This results in the concussive force (117) having two consecutive waves at the top end of the canopy (1)2) outward of the detonation point. The first being the remaining initial wave and the second being the rebounded wave. The area between the two waves serves to provide a moving area of compression while a vacuum will often follow the second wave as the material has been pushed into the area between the waves. The vacuum will typically result in a substantial reduction in the available oxygen and/or fuel within the second wave and will fight the propagation of fire within the surrounding area of the forest (117) by starving the fire within the rebounded area of the second wave of oxygen and/or fuel.

As discussed previously, the concussive force (119) will generally reach the fire by driving some or all of the first portion of water ahead of it and into the fire and ground below. The second portion of water will generally be knocked upwards by the concussive force and will fall onto the area of explosion after the shockwave (upward and away from the earth) has dissipated or lost sufficient force to resist gravity acting on the water. It should be recognized that since water is heavier than air, and that the shockwave upward is directly resisting the the of gravity (and pressure differentials) to return material to the area inside the vacuum formed of the rebounded second wave, water will often enter this area either before or with any air and thus oxygen. This allows for the effects of two water soakings to be additive over time and space. This staged process aids in fire suppression as the fire is initially snuffed by compression and additive water, is then starved for fuel and oxygen, and is then soaked again by water before oxygen can return to resume or continue the reaction.

In an embodiment, an airburst delivery system (101) may be delivered to firefighters as an empty containment vessel (102). Firefighters may then load the containment vessel (102) with an explosive charge (107). Next, the containment vessel (102) may be filled with firefighting material, such as water or a fire retardant chemical. The containment vessel (102) may be completely filled or partially filled with the firefighting material. Once the containment vessel (102) is filled with the firefighting material and an explosive charge (107), the airburst delivery system (101) is ready to be armed and deployed. The airburst delivery system (101) will then be loaded onto an airplane (111) or picked up by a helicopter (113). In another embodiment, the containment vessel (102) may be delivered with a preinstalled explosive charge (107) and/or filled with a firefighting material.

In an embodiment, an airburst delivery system is loaded onto an airplane (111), such as a Lockheed C-130 Hercules airplane. The airplane (111) may be filled with any number of airburst delivery systems (101), as shown in FIG. 2. The task of filling the airplane (111) with the airburst delivery systems (101) may be accomplished on the ground, for example, at an airport or runway. The airplane (111) may then fly to the location of the forest fire within a forest (117). The airburst delivery system (101) has a variable but limited effective radius when deployed. Accordingly, the pilot or crew of the airplane (111) will determine, often in conjunction with other aircraft or crews on the ground, where the airburst delivery system (101) will be deployed. This position may be known as a target. Once a target is acquired, the airburst delivery system (101) may be deployed by dropping the airburst delivery system (101) from the airplane (111) through door(s) (127) of the airplane (111).

Due to the velocity of the airplane (111) relative to the forest (117), the airburst delivery system (101) will follow a trajectory (129) as it falls toward the forest (117). Accordingly, the airplane (111) will fly in a direction towards the target within a portion of the forest (117). The airburst delivery system (101) will be deployed towards the target within a portion of the forest (117) before the airplane (111) is directly overhead of the target. Other factors may be considered in determining where and when to deploy the airburst delivery system (101), including the anticipated effects of any wind or local weather created by the forest fire.

The explosive charge (107) will be armed either before being loaded onto the airplane (111) or while loaded on the airplane (111). When an altimeter is used to determine the timing of detonation, the altimeter detonation system may be set at any time before the airburst delivery system (101) is deployed. When a thermal sensor is used to determine the timing of detonation, the thermal sensor detonation system may be set at any time before the airburst delivery system (101) is deployed. Generally, the detonation system will be set so that the point of detonation (118) is at a detonation altitude (123) that is a preselected distance from the top end of the canopy (122).

As shown in FIG. 4, when the airburst delivery system (101) detonates, the primary means of extinguishing the forest fire will often be the concussive force (119) of the detonation, proximate to the fire. This concussive force (119) by bouncing from the earth's surface serves to, deplete the oxygen levels in the area proximate to the explosion as well as generating primary and secondary shockwaves at the ground and in the canopy which will pass through the fire generally horizontally (across the ground) except for the area generally below the airburst location. As a result, the flames of the fire will often be temporarily extinguished by the concussive shockwave of the blast. The first portion of the water (120) within the airburst delivery system (101) which is pushed into the fire by the blast can serve to deplete flame and heat quickly to reduce the fires ability to survive the resulting effects. The concussive shockwave will then serve to temporarily starve the fire for oxygen in the area behind the shockwave and the second portion of the water (121) within the airburst delivery system (101) will then fall dousing the embers to further cool the previously burning material within the forest fire. This multistage process allows for effective firefighting of forest fires within the proximity of the explosion of the airburst delivery system (101).

When a helicopter (113) is used to deploy an airburst delivery system (101), a similar process to the process discussed previously may be used. However, a trajectory (129) is optional because a helicopter (113) is capable of hovering over a single area and may accordingly deploy the airburst delivery system (101) while having little velocity relative to the forest (117). In any case, multiple airburst delivery systems (101) may be deployed at any given time, or may be deployed successively.

In another embodiment, an airburst delivery system (101) may be used to fight fires under as forest (117) canopy or within a building. In such a case, the airburst delivery system (101) is configured to detonate under the canopy or roof of a structure but above ground level. In this case, the airburst delivery system (101) is able to deliver a concussive force and a firefighting material to the fire without the canopy or roof lessening the effectiveness of the airburst delivery system (101).

It should be recognized that the expanding concussive fame (117) from the explosion can serve to spread burning material horizontally in front of the first wave. In effect, the first wave could carry burning material with it along the front of the wave. However, the front of the wave will also typically have, a wait of water or the other firefighting material carried along too from the containment vessel (102). Thus, the expectation is that the water will serve to extinguish much, if not all, the burning material being carried by the front o f the first wave by forcing it to remain in contact with the carried water for an extended period of time.

Should the fire prove too strong for extinguishment by the airburst delivery system (101) (potentially because of the nature or availability of the fuel), the system (101) can simply be deployed at a point where the airburst delivery system (101) is used to direct the fire and spread is minimized. For example, die system (101) can be deployed to direct the fire a certain direction by using a shaped explosive charge where the resulting concussive waves are far from spherical which can serve to direct the fire in a particular direction. For example, this can be away from populated areas or towards a large natural body of water while serving to extinguish or reduce the intensity of the fire is an opposing direction,

The qualifier “generally,” and similar qualifiers as used in the present case, would be understood by one of ordinary skill in the art to accommodate recognizable attempts to conform a device to the qualified term, which may nevertheless fall short of doing so. This is because terms such as “spherical” are purely geometric constructs and no real-world component or relationship is truly “spherical” in the geometric sense. Variations from geometric and mathematical descriptions are unavoidable due to, among other things, manufacturing tolerances resulting in shape variations, defects and imperfections, non-uniform thermal expansion, and natural wear. Moreover, there exists for every object a level of magnification at which geometric and mathematical descriptors fail due to the, nature of matter. One of ordinary skill would thus understand the term “generally” and relationships contemplated herein regardless of the inclusion of such qualifiers to include a range of variations from the literal geometric meaning of the term in view of these and other considerations.

While the invention has been disclosed in conjunction with a description of certain embodiments, including those that are currently believed to be the preferred embodiments, the detailed description is intended to be illustrative and should not be understood to limit the scope of the present disclosure. As would be understood by one of ordinary skill in the art, embodiments other than those described in detail herein are encompassed by the present invention. Modifications and variations of the, described embodiments may be made without departing from the spirit and scope of the invention.

It will further be understood that any of the ranges, values, properties, or characteristics given for any single component of the present disclosure can be used interchangeably with any ranges, values, properties, or characteristics given for any of the other components of the disclosure, where compatible, to form an embodiment having defined values for each of the components, as given herein throughout. Further, ranges provided for a genus or a category can also be applied to species within the genus or members of the category unless otherwise noted.

1. An airburst delivery system for assisting in firefighting, the system comprising;
a frangible containment vessel;
a firefighting material within said containment vessel;
a explosive charge within said firefighting material; and
a detonator for said explosive charge;
wherein said detonator triggers said explosive charge during descent of said containment vessel from an elevated position toward earth prior to said frangible containment vessel contacting the ground.

2. The airburst delivery system of claim 1 wherein said firefighting material comprises water.

3. The airburst delivery system of claim 1 wherein said detonator includes an altimeter.

4. The airburst delivery system of claim 1 wherein said detonator includes a thermal sensor.

5. The airburst delivery system of claim 1 wherein said containment vessel comprises a rubber blivet.

6. The airburst delivery system of claim 1 wherein said explosive charge comprises C-4 Plastic explosive.

7. The airburst delivery system of claim 6 wherein said explosive charge comprises an M112 demolition charge.

8. The airburst delivery system of claim 1 wherein said system is used in fighting forest fires.

9. The airburst delivery system of claim 8 wherein said detonator triggers said explosive charge above a top edge of a tree canopy.

10. The airburst delivery system of claim 8 wherein said detonator triggers said explosive charge below a top edge of a tree canopy but above the ground.

11. The airburst delivery system of claim 1 wherein said system is carried by an aircraft.

12. The airburst delivery system of claim 11 wherein said aircraft is an airplane.

13. The airburst delivery system of claim 12 wherein said system is carried within said airplane.

14. The airburst delivery system of claim 11 wherein said aircraft is a helicopter.

15. The airburst delivery system of claim 14 wherein said system is carried under said helicopter.
